(19) United States
(12) Patent Application Publication
(10) Pub. No.: US 2018/0082814 A1
(43) Pub. Date: Mar. 22, 2018

(54) Galvanically Isolated Hybrid Contactor

(71) Applicant: Astronics Advanced Electronic Systems Corp., Kirkland, WA (US)

(72) Inventors: Frederick J. Potter, Trumbauersville, PA (US); Patrick Mills, Bradenton, FL (US)

(21) Appl. No.: 15/271,373

(22) Filed: Sep. 21, 2016

(51) Int. Cl. H01H 47/00; H01H 51/30; H01H 49/00

(52) U.S. Cl. CPC H01H 47/007; H01H 49/00; H01H 51/30

(57) ABSTRACT

A hybrid contactor device that provides the ability to use the device with both AC and DC circuits is provided. The hybrid contactor includes a series-parallel arrangement of mechanical contacts with solid state devices, increasing the switching capacity of the mechanical contacts, and maintains galvanic isolation when open. The hybrid contactor includes two mechanical contacts, and is arranged so that one contact closes shortly before the other. The second contact forms a parallel circuit with an electronic switch.

### FIELD OF THE DISCLOSURE

The subject matter of the present disclosure generally relates to circuit control devices, and more particularly relates to a hybrid contactor built with both mechanical and semiconductor switching elements.

### BACKGROUND OF THE DISCLOSURE

U.S. application Ser. No. 14/044,303, titled “Virtual Electronic Circuit Breaker” and commonly owned with the present patent application, discloses a hybrid contactor-based virtual circuit breaker with an electrical relay and control circuit, and is incorporated by reference herein in its entirety.

Control devices for circuits, such as switches, are important in many electrical applications. For instance, various circuit breaker designs that are useful in numerous applications have been previously developed and disclosed.

In current aerospace power distribution systems, electrical loads are fed through a thermal circuit breaker and a power relay connected in-series, in order to provide load and wire protection (over-current or “OC”) and load On/Off control (switching). Alternatively, a Solid State Power Controller (SSPC) may be used to perform these same functions.

The thermal circuit breaker/power relay solution has a long service history, but this combination can be bulky and labor intensive for installation and trouble shooting. The SSPC solution has also been successfully implemented and operated with favorable service history. However, SSPCs are not cost and/or volume effective for higher power loads, largely due to the fact such applications require a high number of metal-oxide-semiconductor field-effect transistors (MOSFETs).

One problem with SSPCs is found with electrical loads greater than 120 VAC, or 25 Amps. In such ranges, SSPCs are large, inefficient and very costly to design and produce. A second problem is that SSPCs are not galvanically isolated, and have a non-zero leakage current when in the “off” state.

It would be desirable, therefore, to provide an electrically controlled switch or circuit breaker, also referred to as a contactor, that combines mechanical contacts and sold state switching elements to provide a small and cost-effective circuit breaker device that performs like an SSPC but also satisfies galvanic isolation requirements for both AC and DC applications

The subject matter of the present disclosure is directed to overcoming, or at least reducing the effects of the problems set forth above.

### BRIEF SUMMARY OF THE DISCLOSURE

Disclosed is a hybrid contactor that provides the ability to use the device with both AC and DC circuits. The contactor is particularly suited for use as an electronically controlled circuit breaker with loads using a 120 Volt AC power at greater than 25 Amps. In such scenarios, solid state electronic circuit breakers are large, inefficient, and very costly to design and produce.

The hybrid contactor includes a series-parallel arrangement of mechanical contacts with solid state devices. This increases the switching capacity of the mechanical contacts, and maintains galvanic isolation when open.

In accordance with the invention, two mechanical contacts are used in series (known as a double-gap contactor), for switching. The contacts are used with one single activating electromagnetic actuator. Closure of the contacts is mechanically arranged, so that one contact closes shortly before the closure of the second contact. The second contact forms a parallel circuit with an electronic switch. The electronic switch may be formed from one or more of semiconductor devices, such as silicon-controlled rectifiers (SCRs), field-effect transistors (FETs), or transistors.

The disclosed subject matter presents several advantages over previously available systems and methods.

One advantage of the disclosed subject matter is that it allows for galvanic isolation between input and output when the contactor is off.

Another advantage of the disclosed subject matter is that it provides arc-less switching, reducing degradation of the inventive device.

Yet another advantage of the disclosed subject matter is that an inexpensive semiconductor may be utilized.

Yet another advantage of the disclosed subject matter is that heat dissipation from the inventive device is greatly reduced.

Yet an additional advantage of the disclosed subject matter is elimination of relay contact failure.

### BRIEF DESCRIPTION OF THE DRAWINGS

The foregoing summary, preferred embodiments, and other aspects of the subject matter of the present disclosure will be best understood with reference to a detailed description of specific embodiments, which follows, when read in conjunction with the accompanying drawings, in which:

FIG. 1 is a diagram of an embodiment of the invention, illustrating the series-parallel arrangement.

FIG. 2 is a schematic diagram of the contactor closing in accordance with the invention.

FIG. 3 is a schematic diagram of the contactor opening in accordance with the invention.

Like reference numbers and designations in the various drawings indicate like elements. Arrows in the schematic drawings should be understood to represent logic pathways that are generally indicative of the flow direction of information or logic, and that such arrows do not necessarily represent traditional electrical pathways.

### DETAILED DESCRIPTION OF THE DISCLOSURE

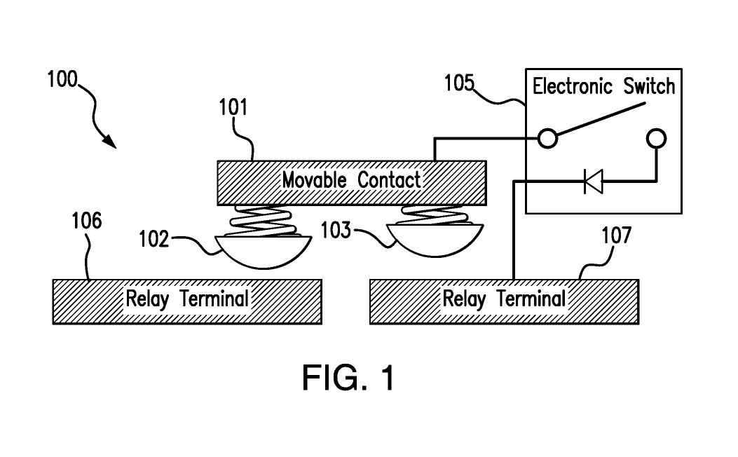

FIG. 1 is a schematic diagram of one embodiment of the inventive hybrid contactor 100. A movable contact 101 includes two mechanical contacts 102 and 103 used in series. Mechanical contacts 102 and 103 form a double gap contactor, with a single activating electromagnetic actuator. Mechanical contacts 102 and 103 are mechanically arranged in accordance with the invention such that, upon activation of the magnetic contact closure device, contact 102 closes shortly before the second of contact 103.

The second mechanical contact 103 is electronically arranged in a parallel circuit 104 to an electronic switch 105. Electronic switch 105 may include one or more semiconductor devices, such as an SCR, FET, transistor, or any other suitable semiconductor device.

In an illustrative sequence, closure of the first contact 102 causes power to be applied to the electronic switch 105. The electronic switch 105 begins conducting current in parallel 104 with the second contact 103. Shortly after the electronic switch 105 begins flowing current through the device, the second contact 103 closes. Closure of the second contact 103 causes a shorting out of the electronic switch 105.

Opening of the contacts is performed in the exact reverse sequence. Contact 103 opens first, causing the load current to flow through electronic switch 105. Switch 105 is then turned off before contact 102 begins to open. In accordance with the invention, all switching stress is borne by the electronic switch 105, and no arcs are initiated in mechanical contacts 102, 103 at any time.

Electronic switch 105 carries at least some current at all times, when both contacts 102 and 103 are closed. At the times when the contact 103 is open and contact 102 is closed, electronic switch 105 carries the entire load current. By carrying the entire load current during an opening or closing of contacts, switching stress on the relay contacts 106 and 107 is substantially reduced or eliminated. Switching stress is a major cause of relay degradation, and thus elimination of switching stress greatly reduces relay degradation and prolongs the service life of the contactor device.

Semiconductor device 105a (not shown) is only utilized to handle current during switching transitions, thereby only causing minimal heat dissipation (which results from semiconductor use) and stress. Thus, infrequent use of semiconductor device 105a, e.g. only during switching transitions, reduces heat dissipation and stress. When the semiconductor device 105a is off, galvanic isolation (e.g., an air gap) is present between input and output. Additionally, galvanic isolation is also present between relay terminals 106 and 107 and ground.

It should be noted that the invention is specifically contemplated using an SCR or triode for alternating current (TRIAC) as the electronic switch for AC devices, and FET, Insulated Gate Bipolar Transistors (IGBT), or Bipolar Junction Transistors (BJT) as the electronic switch for either AC or DC devices. However, any other suitable electronic switch is contemplated by the invention, and can be utilized in accordance with the inventive process disclosed herein.

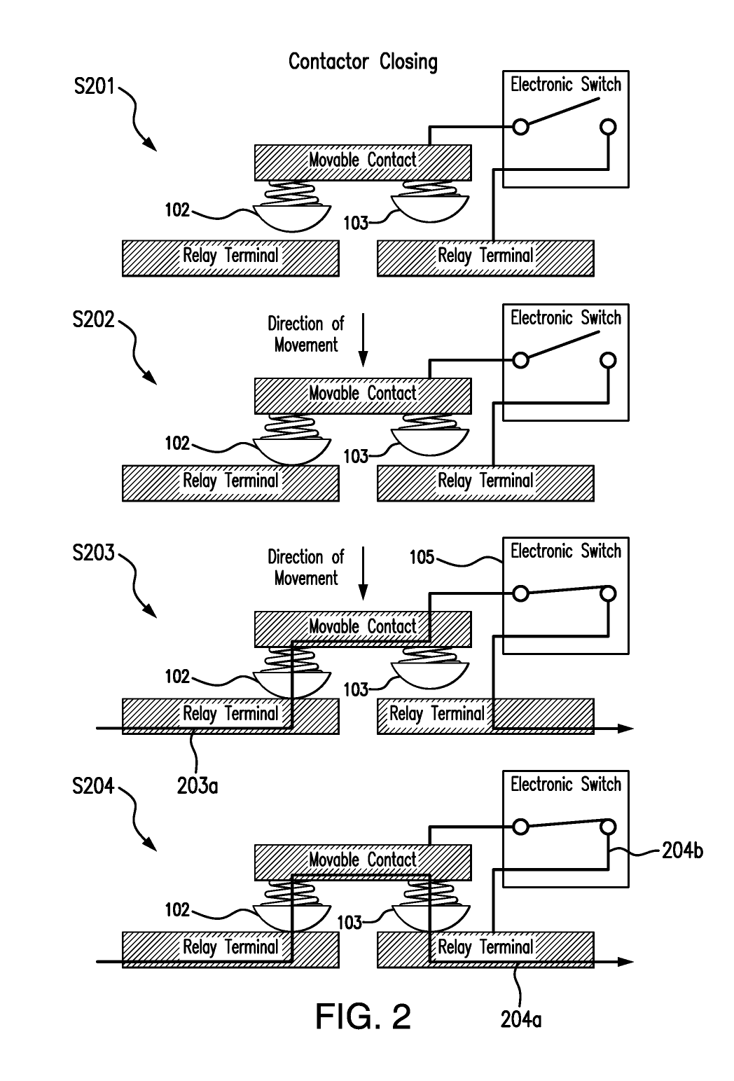

FIG. 2 is a schematic diagram illustrating an embodiment of the invention. In FIG. 2, the contactor 100 of FIG. 1 is illustrated moving to a closed position.

At S201, the inventive hybrid contactor is illustrated in initial position. Contacts 102 and 103 are illustrated in a switched open position. Electronic switch 105 is open, and no current is flowing. Input to output are galvanically isolated, forming an air gap.

At S202, an intermediate position, mechanical contact 102 closes, as a result of movement of the movable contact 101 in the direction toward (or downward to) relay terminals 106 and 107. This causes the mechanical contact 102 to make contact with relay terminal 106, halting galvanic isolation. At this stage, electronic switch 105 is still in an open position, and no current is therefore flowing in the circuit.

At S203, a subsequent intermediate position, electronic switch 105 is now closed. As shown, current begins to flow at this position. Illustrative flow of current is shown as path 203a. At this position, voltage across the electronic switch is less than 8V.

At S204, the inventive hybrid contactor is shown in a final closed position. At this position, the second mechanical contact 103 closes, making electrical contact with relay terminal 107. This causes electronic switch 105 to be shorted as a result of the closure of mechanical contact 103. As a result of the shorting out of electronic switch 105, a substantial portion of the electrical current changes the path of flow, shifting to a low resistance mechanical path. The low resistance mechanical path is shown in path 204a, while the former path is illustrated in 204b.

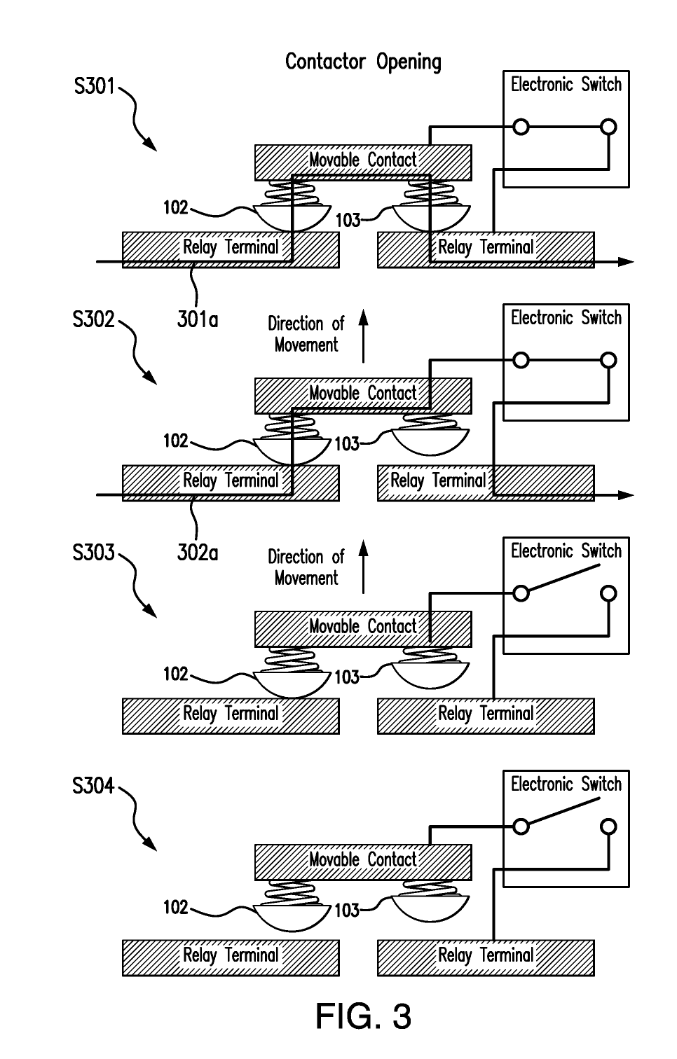

FIG. 3 is a schematic diagram illustrating an exemplary embodiment of the opening of hybrid contactor 100 in accordance with the invention.

At S301, hybrid contactor 100 is shown in an initial closed position. At this position, previously illustrated in S204, mechanical contacts 102 and 103 are in electrical contact with relay terminals 106 and 107, respectively, and form a closed circuit. The electronic switch 105 is closed, and current flows through path 301a. Thus, at this position, current is not flowing through the semiconductor device 105a.

At S302, an intermediate position, moveable contact 101 moves in an upward position, away from relay terminals 106 and 107. Mechanical contact 103 opens, releasing contact from relay terminal 107 and forming an open position. At this point, all current flows through mechanical contact 102 and then into electronic switch 105. It is at this stage, during the relay switching operation, that semiconductor device 105a must carry the current. Voltage of less than 8V now moves across the electronic switch 105. Illustrative path 302a shows the flow of the current at this position.

At S303, a subsequent intermediate position, electronic switch 105 opens, halting all current flow. At this point, no more current is being carried by semiconductor device 105a. Thus, while mechanical contact 102 remains in electrical contact with relay terminal 106, the opening of electronic switch 105 prevents formation of a closed circuit and therefore the flow of current.

At S304, the final position, mechanical contact 102 releases contact from relay terminal 106, forming an open position. At this point, both mechanical contacts 102 and 103, as well as electronic switch 105, are in an open position, and no current is flowing. The input to output is now galvanically isolated.

In view of the foregoing embodiments, an advantage of the inventive hybrid contactor 100 allows for galvanic isolation between the input and output. By providing an air gap between the first contact 102 and relay terminal 106, true galvanic isolation is provided between input and output when the contactor is off. This allows for high potential to be applied between input and output, or between both terminals and ground, all the way up to the voltage limit, which is determined by the distance of the air gap.

An additional advantage of the inventive hybrid contactor is arc-less switching. That is, during switching, the mechanical contacts 102 and 103 do not arc, ensuring little or no contact degradation during operation of the hybrid contactor. By only requiring the semiconductor device 105a to carry current for a short time during the relay switching operation, a relatively small and inexpensive semiconductor may be utilized. During normal operation, the mechanical contacts 102 and 103 carry all the current, which causes the semiconductor device 105a to dissipate no heat, and therefore further reduces the cost and complexity by not requiring a large heat sink.

Yet an additional advantage of the inventive hybrid contactor is elimination of mechanical vibration arcing and subsequent failure of the relay contacts.

It should be understood that various components of the disclosed subject matter may communicate with one another in various manners. For instance, components may communicate with one another via a wire or, alternatively, wirelessly and by electrical signals or via digital information. It is noted that PWB may be utilized in the construction of many embodiments.

Although the disclosed subject matter has been described and illustrated with respect to embodiments thereof, it should be understood by those skilled in the art that features of the disclosed embodiments can be combined, rearranged, etc., to produce additional embodiments within the scope of the invention, and that various other changes, omissions, and additions may be made therein and thereto, without parting from the spirit and scope of the present invention.

1. A hybrid contactor device, comprising:
a moveable contact including a first mechanical contact and a second mechanical contact;
an electrical switch in electrical communication with the second mechanical contact; and
a first terminal relay configured to electrically engage the first mechanical contact and a second terminal relay configured to electrically engage the second mechanical contact,
wherein when the first mechanical contact and the second mechanical contact are open, galvanic isolation is formed between input and output.

2. The contactor device of claim 1 wherein the first mechanical contact is in a closed position, forming electrical and mechanical contact with the first terminal relay, the closed position effective to cause power to be applied to the electrical switch.

3. The contactor device of claim 2 wherein, after a delay, the electrical switch causes current to flow through the contactor device.

4. The contactor device of claim 3 wherein the second mechanical contact moves to a closed position after closure of the first mechanical contact, causing a shorting of the electrical switch.

5. The contactor device of claim 1 wherein the first mechanical contact and the second mechanical contact are arranged in series.

6. The contactor device of claim 1 wherein the electrical switch is arranged in parallel to the second mechanical contact.

7. The contactor device of claim 1 wherein the first mechanical contact and the second mechanical contact form a double gap contactor with a single activating electromagnetic actuator.

8. The contactor device of claim 1 wherein the electrical switch includes a semiconductor device.

9. The contactor device of claim 8 wherein the semiconductor device is selected from a group consisting of a silicon-controlled rectifier (SCR), field-effect transistor (FET) or transistor.

10. The contactor device of claim 1 wherein the electrical switch is selected from a group consisting of SCR, three-terminal semiconductor (TRIAC), FET, insulated-gate bipolar transistor (IGBT), or bipolar junction transistor (BJT) switches.

11. A method of forming a hybrid contactor device, comprising the steps of:
providing a first mechanical contact;
providing a second mechanical contact;
providing an electrical switch in communication with the second mechanical contact;
providing a first terminal relay;
receiving, via the first terminal relay, an electrical engagement from the first mechanical contact;
providing a second terminal relay; and
receiving, via the second terminal relay, an electrical engagement from the second mechanical contact,
wherein when the first mechanical contact and second mechanical contact are open, galvanic isolation is formed between input and output.

12. The method of claim 11 further comprising:
closing the first mechanical contact, the closing comprising forming mechanical and electrical contact with the first terminal relay; and
causing power to be applied to the electrical switch.

13. The method of claim 12 wherein the electronic switch is further configured to conduct current in parallel with the second contact.

14. The method of claim 13 further comprising:
closing the second mechanical contact, the closing comprising forming mechanical and electrical contact with the second relay terminal; and
causing a shorting of the electrical switch.

15. The method of claim 14 wherein, when either of the first mechanical contact or the second mechanical contact are in a closed position, the electrical switch is configured to carry an entire current load.

16. A method of forming a hybrid contactor device comprising the steps of:
providing a first mechanical contact and a second mechanical contact in a switched open position;
closing the first mechanical contact, the closing effective to cause the first mechanical contact to couple electrically with a first relay terminal;
providing an electrical switch;
closing the electrical switch after closure of the first mechanical contact; and
closing the second mechanical contact after the electrical switch has been closed.

17. The method of claim 16 wherein, when the first mechanical contact is closed, the electrical switch remains in an open position, and does not flow current through the circuit.

18. The method of claim 17 wherein when the electrical switch remains in an open position, the preventing of the flow of current is effective to form galvanic isolation.

19. The method of claim 16 wherein, upon closure of the second mechanical contact, the electrical switch is shorted, the short effective to cause a substantial portion of the electrical current to change its flow to a low-resistance mechanical path.

20. The method of claim 16 wherein, when the first mechanical contact is in a closed position and the second mechanical contact is still in a switched open position, the method further comprises flowing all current through the first mechanical contact and into the electrical switch.
